(19) United States
(12) Patent Application Publication
(10) Pub. No.: US 2007/0149656 A1
(43) Pub. Date: Jun. 28, 2007

(54) Sprayable mining liner composition

(75) Inventor: Terry J. Rayner, London (CA)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/317,865

(22) Filed: Dec. 23, 2005

(51) Int. Cl. C08L 5/00

(52) U.S. Cl. 524/27

(57) ABSTRACT

A composition for producing a liner comprises (a) at least one water-borne, non-cellulosic precursor of a polyurethane; and (b) at least one wet pulp.

### FIELD

The invention relates to an elastomeric polymeric film that can be used as a load-bearable coating, for example, to assist in protecting from rock bursts in a mine. The invention also relates to a method for providing support to surfaces such as, for example, rock surfaces.

### BACKGROUND

Underground mining requires support of the back (roof) and walls of the mine to prevent injury due to rock bursts or falling loose rock. A variety of materials have been used for this purpose, including shotcrete, wire mesh, and sprayable liner compositions. Both shotcrete and wire mesh are somewhat difficult to handle and apply in the underground mines, more particularly in deep mining applications. The application of shotcrete/gunite is labor intensive, and the linings are generally brittle, lacking in significant tensile strength and toughness, and prone to fracturing upon flexing of the rock during mine blasting. In addition, shotcrete/gunite generally develops its desired early tensile strength of about 1 MPa only slowly.

Sprayable liners can develop strength quickly but are often toxic during spray application. Those that have low toxicity during spray application are often not tough enough and generally require more than four hours (at ambient temperature without application of heat) to develop the minimum early strength desired to be useful in a mining environment.

For example, the use of water-borne components in sprayable compositions can aid in reducing their toxicity but can also limit their development of mechanical strength, as the rate of strength buildup is, to at least some extent, controlled by the rate of diffusion of water from the applied composition. This rate of diffusion can be significantly affected by temperature, humidity, and airflow conditions, which can be somewhat difficult to control in a mining environment. Reinforcing agents can be added to the compositions but can detrimentally impact their stability, processability, and/or sprayability, as well as their mechanical properties such as tensile strength, toughness, elongation, and/or adhesion.

### SUMMARY

Thus, we recognize that a tough, flexible, easy-to-apply, quick strength-developable (at ambient temperature) liner is needed. The present invention provides a composition for producing such a liner, which comprises
(a) at least one water-borne, non-cellulosic precursor of a polyurethane (preferably, the precursor is a precursor of a polyurethane hydrogel; more preferably, the precursor is a water-borne, non-cellulosic polymer dispersion, the polymer bearing groups that are reactive with isocyanate groups); and
(b) at least one wet pulp (preferably, a wet aramid pulp).

The composition of the invention, in spite of its water content, can be used (for example, in combination with a hydrophilic isocyanate prepolymer) to produce a polymeric liner that exhibits surprisingly enhanced initial yield strength (measured 2-6 hours following application) relative to a liner produced from the corresponding composition without wet pulp. Although the resulting liner is preferably a polyurethane hydrogel (and thus at least somewhat hydrophilic in nature), it can exhibit surprising ultimate load-bearing capability (upon complete cure) and, prior to complete drying, can generally develop sufficient strength to be useful in a load-bearing capacity (for example in a mining environment) within 24 hours and, often, within about 4 hours.

It has been discovered that wet pulp can be added to sprayable, water-based liner compositions (with maintenance of their processability and sprayability) and can function to enhance the initial yield strength of liners produced from the compositions, without significantly impacting the other mechanical properties of the liners (for example, tensile strength, toughness, elongation, and/or adhesion). The compositions comprising wet pulp are stable and can be easily applied (for example, after combination with other polyurethane precursors) to surfaces by spraying, yet cure to provide tough, flexible coatings. Thus, at least some embodiments of the composition of the invention can meet the need for tough, flexible, easy-to-apply, quick strength-developable (at ambient temperature) liners.

In other aspects, the invention provides a liner comprising the polymeric product of reaction of the composition of the invention, as well as a mine opening and a building structure (having at least one non-trafficable surface that is) at least partially lined with the liner.

In yet another aspect, the invention also provides a process for providing a surface with a polymeric liner, the method comprising (a) applying to the surface the composition of the invention; and (b) effecting reaction of the composition to form the liner.

In still another aspect, this invention further provides a kit for producing a liner, the kit comprising the composition of the invention, which, when subjected to reaction conditions, reacts to form a polymeric material suitable for use as a liner.

### DETAILED DESCRIPTION

Definitions

As used in this patent application:

“aramid” means an aromatic polyamide;

“fibrillated” (in regard to fibers or fibrous material) means treated (for example, by beating) in a manner that increases the surface area of the fibers (for example, by the formation of fibrils or branches);

“high-fibrillated” (in regard to fibers or fibrous material) means exhibiting a Canadian Standard Freeness value (measured according to TAPPI Test Method T227 om-04 (Technical Association for Pulp and Paper Industry, Atlanta, Ga.)) of less than about 250;

“liner” means a load-bearable coating that can be applied to a surface (for example, the surfaces of mining cavities, highway overpasses and underpasses, and roadsides, for example, to provide support and/or to contain loose or falling debris);

“low-fibrillated” (in regard to fibers or fibrous material) means exhibiting a Canadian Standard Freeness value (measured according to TAPPI Test Method T227 om-04 (Technical Association for Pulp and Paper Industry, Atlanta, Ga.)) of at least about 350 (preferably, at least about 500);

“modulus” means tensile modulus and/or storage modulus;

“para-aramid” means an aromatic polyamide having its amide linkages bonded to substituted (for example, alkyl-substituted) or unsubstituted benzene rings in para-relation (bonded to carbon numbers one and four);

“polyurethane hydrogel” means a crosslinked polyurethane network that, in the presence of water, absorbs the water (for example, due to its hydrophilicity) and thereby becomes swollen;

“24-hour Tensile Strength” and “4-hour Tensile Strength” mean a tensile strength value that is measured 24 hours and 4 hours, respectively, after mixing all composition components according to ASTM D-412-98a (reapproved 2002; Standard Test Method for Vulcanized Rubber and Thermoplastic Elastomers-Tension, published by American Society for Testing and Materials, West Conshohocken, Pa.) modified by utilizing a crosshead speed of 200 mm per minute, a sample width of 0.635 cm (0.25 inch), and a gauge separation of 3.81 cm (1.5 inches);

“water-borne” (in regard to a polyurethane precursor) means that water is present (as a carrier for the precursor) in an amount of at least about 25 percent by weight (preferably, at least about 30 percent by weight; more preferably, at least about 40 percent by weight; most preferably, at least about 50 percent by weight), based on the total weight of precursor and water;

“wet pulp” means fibrous material that is capable of being fibrillated and that comprises at least about 20 percent by weight water (preferably, at least about 40 percent by weight water; more preferably, at least about 60 percent by weight water), based on the total weight of the wet pulp;

“yield strength” means the amount of strain that must be applied to a material to cause it to cease recoverable elastic deformation and to undergo permanent (irreversible) plastic deformation; and

“24-hour Yield Strength” and “4-hour Yield Strength” mean a yield strength value that is measured 24 hours and 4 hours, respectively, after mixing all composition components according to ASTM D-412-98a (reapproved 2002; Standard Test Method for Vulcanized Rubber and Thermoplastic Elastomers-Tension, published by American Society for Testing and Materials, West Conshohocken, Pa.) modified by utilizing a crosshead speed of 200 mm per minute, a sample width of 0.635 cm (0.25 inch), and a gauge separation of 3.81 cm (1.5 inches).

Water-Borne Precursors of a Polyurethane

Precursors suitable for use in the composition of the invention include those that are water-borne and that are capable of reacting with themselves or with other precursors (for example, hydrophilic isocyanate prepolymers) to form a polyurethane. Suitable polyurethane precursors include water-borne polymer dispersions, the polymer bearing groups that are reactive with isocyanate groups, with acryloyl or methacryloyl groups, with epoxy groups, with acid chloride groups, and the like, and mixtures thereof. Preferably, the precursor is a precursor of a polyurethane hydrogel; more preferably, the precursor is a water-borne polymer dispersion, the polymer bearing groups that are reactive with isocyanate groups.

In preferred embodiments of the composition of the invention, preferred polyurethane precursors are water-borne polymer dispersions comprising polymers that are sufficiently stiff that a film prepared from the polymer (for example, by casting the polymer dispersion) has a tensile modulus (measured according to ASTM D-412-98a (reapproved 2002; Standard Test Method for Vulcanized Rubber and Thermoplastic Elastomers-Tension, published by American Society for Testing and Materials, West Conshohocken, Pa.) modified by utilizing a crosshead speed of 200 mm per minute, a gauge separation of 3.81 cm, and a sample thickness of 1.0 mm) of at least about 5 MPa at 100% elongation (more preferably at least about 10 MPa at 100% elongation, and most preferably at least about 15 MPa at 100% elongation) or a storage modulus of at least about 5×10⁸ dynes/cm² (more preferably, at least about 1×10⁹ dynes/cm²) measured using a dynamic mechanical analyzer (DMA; for example, a Rheometrics™ RDA-2) at a sample thickness of 1.5 mm and a frequency of 1 hertz in an 8-mm parallel plate at room temperature. More preferably, both the tensile modulus and the storage modulus of the polymer fall within the respective preferred ranges. Preferred polymers have a glass transition temperature or crystalline melting temperature (value of T_{g} or Tₘ) greater than about 30° C., more preferably greater than about 40° C., most preferably greater than about 50° C.

Other preferred features of the polymer include (i) that it has a molecular weight (M_{w} in g/mol as measured by gel permeation chromatography (GPC) versus polystyrene standards) in the range of at least about 50,000, more preferably from about 100,000 to about 700,000; (ii) that it is in the form of particles of an average size from about 10 to about 10,000 nm, more preferably from about 30 to about 1000 nm, most preferably from about 30 to about 500 nm; and (iii) that the polymer is used as a dispersion in water containing essentially no organic solvent (for example, N-methyl pyrrolidone).

Surprisingly, dispersions of even high modulus, high T_{g} or Tₘ polymers can be used to obtain films (for example, upon reaction with other polyurethane precursors) without the need for co-solvent (or added heat).

The polymer preferably bears one or more groups that are reactive to isocyanate groups (preferably, hydroxyl (alcohol), primary or secondary amino, or carboxylic acid groups; more preferably, amino or hydroxyl groups; even more preferably, amino groups; most preferably primary amino groups). Preferably, the polymer has an average reactive group functionality of at least about one, more preferably at least about 2.

Polymer dispersions that can be used include polyurethane dispersions, poly(styrene-acrylic) dispersions, and the like, and mixtures thereof. Especially preferred are the polymer dispersions commonly represented in the art by the term “polyurethane dispersions,” which is generally recognized (and used herein) to encompass such polymer dispersions as polyurea dispersions, polyurethane dispersions, polythiocarbamate dispersions, and dispersions of combinations thereof (for example, mixtures of polyurea dispersions and polyurethane dispersions, as well as dispersions such as poly(urethane-urea) dispersions), as well as dispersions of polyurethane-polyvinyl hybrids (preferably “copolymers” comprising semi-interpenetrating polymer networks) including, for example, polyurethane-polyacrylic dispersions. The typical waterborne polyurethane dispersion is often a poly(urethane-urea) dispersion due to reaction of some isocyanate with water, followed by decarboxylation as described below, or due to chain extension by diamines. Most preferred are polyurethane-polyacrylic dispersions.

Water-borne polymers and processes for their preparation are known, and many are commercially available. Examples of water-borne polyurethanes and such processes are described in “Advances in Urethane Science and Technology”, Waterborne Polyurethanes, James W. Rosthauser and Klaus Nachtkamp, Vol. 10, pp. 121-162, Mobay Corp., Pittsburgh, Pa. (1989), the description of which is incorporated herein by reference. The water-borne polyurethane dispersion can be made, for example, according to one of the methods described in this reference. Other suitable examples of water-borne polyurethane dispersions and processes for their preparation are described in U.S. Pat. No. 5,312,865 (Hoefer et al.); U.S. Pat. No. 5,555,686 (Bird et al.); U.S. Pat. No. 5,696,291 (Bechara et al.); U.S. Pat. No. 4,876,302 (Noll et al.); and U.S. Pat. No. 4,567,228 (Gaa et al.); the descriptions of which are incorporated herein by reference. A preferred method for forming the water-borne polyurethane dispersion is the prepolymer method. Dispersions of polymers other than polyurethanes and processes for their preparation are described, for example, in Encyclopedia of Polymer Science and Engineering, Volume 6, pages 1-48, Wiley-Interscience, New York (1986), the description of which is incorporated herein by reference.

The water-borne polymer is preferably hydrophobic in nature to reduce or prevent hydrolysis of its polymeric backbone. The hydrolytic resistance of the polymer can depend on the backbone of its precursor (for example, in the case of a polyurethane, the polyol) that is used in its synthesis. Useful precursor polyols include, for example, polyether polyols, polyester polyols, polycarbonate polyols, and the like, and mixtures thereof. Normally adipic acid-based polyester polyols are more resistant to hydrolysis than phthalate-based polyester polyols. The polyurethane dispersions made from prepolymers having polyols based on polycarbonate or dimer acid diol generally have higher hydrolytic resistance than polyester-based polyols.

Suitable water-borne polyurethanes include, for example, NEOPAC 9699, a water-borne urethane/acrylic based polyurethane (40% solids), and NEOPAC R-9050, a water-borne urethane/acrylic based polyurethane (50% solids), both available from DSM NeoResins, Wilmington, Mass., USA; HAUTHANE HD 2334, a polyether water-borne urethane dispersion (45% solids) available from Hauthaway Corporation, Lynn, Mass.; HYBRIDUR 580, a polyester-acrylic based urethane dispersion (41% solids), HYBRIDLIR 570, an acrylic-urethane hybrid polymer dispersion (41% solids), HYBRIDUR 878, an aliphatic urethane-acrylic hybrid dispersion (40% solids), and HYBRIDUR 870, a urethane-acrylic hybrid polymer dispersion (40% solids), all available from Air Products and Chemicals, Inc., Allentown, Pa., USA; and the like; and mixtures thereof.

The amount of water present in these commercially available dispersions ranges from about 35 percent or 50 percent to about 65 percent or 70 percent by weight. This range is normally satisfactory for use in the composition of the invention. Use of amounts of water outside of this range are, however, within the scope of this invention, and the percentage of water can be readily adjusted. Generally, useful water-borne polymer dispersions will have a solids content (content of solid polymer) of at least about 25 percent by weight (preferably, at least about 30 percent by weight; more preferably, at least about 40 percent by weight; most preferably, at least about 50 percent by weight) based upon the total weight of the dispersion. Preferably, the dispersion contains no more than about 80 percent (more preferably, no more than about 70 percent; most preferably, no more than about 60 percent) water by weight, based upon the total weight of the dispersion.

Other water-borne polymeric emulsions (such as emulsions of various acrylic, styrene butadiene, or vinyl acetate polymers) that form a continuous liner film of lower tensile strength (than the preferred values described above for polymers) can replace part of the water-borne polymer dispersion. Examples include RHOPLEX EC 2848 and RHOPLEX 2438 (acrylic emulsions available from Rohm & Haas Company, Philadelphia, Pa.). However, these emulsions generally reduce the initial (4 hrs) and ultimate tensile strengths of the resulting liner and generally cannot provide the strengths that can be preferred for certain applications (for example, a tensile strength of at least about 1 MPa within about 4 hours at room temperature (preferably within about two hours)).

Wet Pulp

Wet pulps that are suitable for use in the composition of the invention comprise water (at least about 20 percent by weight, based on the total weight of the wet pulp) and fibrous material that is capable of being fibrillated. Preferably, the wet pulp comprises at least about 40 percent by weight water (more preferably, at least about 60 percent). Useful fibrous materials include natural animal and vegetable fibers (for example, wool, silk, cellulose, and the like, and mixtures thereof), synthetic fibers (for example, polyamides, polyesters, polyacrylics, polyolefins, and the like, and mixtures thereof), and the like, and mixtures thereof. Such fibrous materials are known, and some are commercially available. Preferably, the fibers are fibrillated; more preferably, the fibers are low-fibrillated, as low-fibrillated fibers can enhance the initial yield strength of liners prepared from the composition of the invention while maintaining composition processability and sprayability.

Preferred fibrous materials include cellulose fibers, polyolefin fibers (for example, polyethylene, polypropylene, and the like, and mixtures thereof), and polyamide fibers (for example, aramid fibers). More preferred are polyamide fibers (preferably, aramid fibers; more preferably, para-aramid fibers), with poly(paraphenylene terephthalamide) fibers being most preferred.

The fibers are preferably at least somewhat flexible, as this can enhance the sprayability of the composition of the invention. The average fiber length is preferably at least about 100 micrometers (more preferably, at least about 300 micrometers; most preferably, at least about 500 micrometers). The average fiber length, however, preferably does not exceed about 3000 micrometers or 3 millimeters (more preferably, about 2500 micrometers; most preferably, about 2000 micrometers). Thus, the average fiber length can range from any of the above-listed lower length limits to any of the above-listed upper length limits.

Wet pulp can be included in the composition of the invention in a wide range of amounts, depending upon the particular properties desired in the resulting liner. It can sometimes be preferred, however, to include no more than about five parts wet pulp (more preferably, no more than about 2 parts wet pulp; most preferably, no more than about one part wet pulp) per one hundred parts of solids in the water-borne polyurethane precursor. Useful properties can be achieved at levels as low as about 0.1 part wet pulp (more preferably, at least about 0.3 part wet pulp; most preferably, at least about 0.5 part wet pulp) per one hundred parts of solids in the water-borne polyurethane precursor.

The wet pulp can preferably be added to the water-borne polyurethane precursor, and such addition can preferably be effected prior to combination of the water-borne precursor with any other material(s). Low shear agitation can preferably be utilized to facilitate the mixing of the wet pulp and the water-borne precursor (for example, agitation at 500-600 revolutions per minute for a period of 1-4 hours, depending upon the degree of fibrillation of the fibers in the wet pulp). High-fibrillated wet pulps can sometimes benefit from longer mixing times in order to achieve a desired level of dispersion in the water-borne precursor.

Preparation of Liner

To form a liner, the above-described mixture of water-borne precursor and wet pulp can be subjected to reaction conditions that can enable the formation of a polyurethane. This often involves the addition of other reactive components to the mixture.

For example, when the precursor is a water-borne dispersion of a polymer bearing isocyanate-reactive groups, the precursor can be combined with at least one hydrophilic isocyanate prepolymer. Hydrophilic isocyanate group-bearing prepolymers suitable for use are those that are capable of reacting with the polymer of the water-borne dispersion to form a crosslinked hydrogel. Such prepolymers are well-known in the art.

Generally, the preparation of such prepolymers involves the reaction of a polyfunctional active hydrogen-containing compound with a diisocyanate or other polyisocyanate, using an excess of the isocyanate to yield an isocyanate-terminated prepolymer product. An extensive description of some of the useful techniques for preparing suitable isocyanate prepolymers can be found in the text by J. H. Saunders and K. C. Frisch entitled Polyurethanes: Chemistry and Technology, Part II, pages 8-49 and cited references, Interscience Publishers, New York (1964). Other known preparative techniques can also be employed. Preferably, the prepolymers have an average isocyanate functionality of at least about 2 (more preferably, about 2 to about 5; most preferably, about 2 to about 3).

Some of the isocyanate groups of the hydrophilic prepolymer can react with water to form carbamic acid moieties which immediately decarboxylate to generate amines.

These amines can then react with other isocyanate groups to lead to crosslinking of the prepolymer. Water can be absorbed into the ethylene oxide matrix of the product leading to formation of a gel.

Suitable polyfunctional active hydrogen-containing compounds for use in preparing the prepolymers include polyols, polyamines, polythiols, and the like, and mixtures thereof. Polyols are generally preferred.

Useful polyols include polyester, polyether, polycarbonate, and polyether polyester polyols having an average hydroxyl functionality of at least about 2 (preferably, about 2 to about 3) and a molecular weight greater than about 500 (preferably, in the range of about 500 or 1,000 to about 5,000 or 10,000), so as to provide prepolymer having a molecular weight in the range of about 1,000 to about 10,000. Also useful are acrylic polyols of such functionalities having a degree of polymerization of about 3 to about 50 and a molecular weight of about 360 to about 6000, as well as low molecular weight glycols (for example, having a molecular weight in the range of about 62 to about 250).

Preferred polyols have molecular weights that enable the preparation of liquid prepolymers. Polycarbonates, polyethers, and polyesters are generally preferred, with polyethers being more preferred.

Suitable polyester polyols include those formed from diacids (or their monoester, diester, or anhydride counterparts) and diols or triols. Useful diacids include saturated C₄-C₁₂ aliphatic acids (including branched, unbranched, or cyclic materials) and/or C₈-C₁₅ aromatic acids. Examples of suitable aliphatic acids include, for example, succinic, glutaric, adipic, castor fatty acid, pimelic, suberic, azelaic, sebacic, 1,12-dodecanedioic, 1,4-cyclohexanedicarboxylic, 2-methylpentanedioic acids, and the like, and mixtures thereof. Examples of suitable aromatic acids include, for example, terephthalic, isophthalic, phthalic, 4,4′-benzophenone dicarboxylic, 4,4′-diphenylamine dicarboxylic acids, and the like, and mixtures thereof. Useful diols include C₂-C₁₂ branched, unbranched, or cyclic aliphatic diols. Examples of suitable diols and triols include, for example, ethylene glycol, glycerine, neopentyl glycol, 1,3-propylene glycol, trimethylol propane, 1,2-propylene glycol, 1,4-butanediol, 1,3-butanediol, hexanediols, 2-methyl-2,4-pentanediol, cyclohexane-1,4-dimethanol, 1,12-dodecanediol, and the like, and mixtures thereof.

Suitable polyether polyols include polyoxy-C₂-C₆-alkylene polyols (having branched or unbranched alkylene groups). Examples of suitable polyether diols include, for example, polyethylene oxide, poly(1,2- and 1,3-propyleneoxide), poly(1,2-butyleneoxide), random or block copolymers of ethylene oxide and 1,2-propylene oxide, polytetramethylene glycols, propylene glycol, neopentyl glycol, hexanediol, butanediol, and the like, and mixtures thereof.

Suitable polyester polyether polyols can be made from polyethers having a molecular weight of about 200 to about 2000 and a functionality of about 2 to about 3, with acids, for example, such as adipic acid, phthalic acid, isophthalic acid, or terephthalic acid.

Suitable polycarbonate polyols include aliphatic polycarbonate diols and the like, and mixtures thereof.

Suitable acrylic polyols include polyols based on monoethylenically unsaturated monomers such as monoethylenically unsaturated carboxylic acids and esters thereof, styrene, vinyl acetate, vinyl trimethoxysilane, acrylamides, and the like, and mixtures thereof. Useful monomers include but are not limited to methyl acrylate, butyl acrylate, ethyl acrylate, 2-ethylhexyl acrylate, hydroxybutyl acrylate, hydroxyethyl acrylate, glycidyl acrylate, lauryl acrylate, acrylic acid, and the like, and mixtures thereof. The polymers can be homopolymers or copolymers. The copolymers can also contain a significant number of units derived from methacrylate monomers (for example, methyl methacrylate, butyl methacrylate, hydroxyethyl methacrylate, lauryl methacrylate, glycidyl methacrylate, methacrylic acid, and the like, and mixtures thereof). Preferred acrylic polyols include hydroxy-functional oligomers prepared by the process described in U.S. Pat. No. 5,710,227 (Freeman et al.) and EP Patent No. 1 044 991 (Rohm and Haas Company), wherein the oligomers have a degree of polymerization (DP) of about 3 to about 50 and a molecular weight of about 360 to about 6000 (preferably, a DP of about 5 to about 20 and a molecular weight of about 600 to about 2400).

A suitable, relatively low-cost hydrophilic polyol for use in the preparation of the hydrophilic prepolymer bearing isocyanate groups is a polyether polyol having at least two, preferably three, hydroxyl groups, and a number average molecular weight in the range of from about 2,000 to about 20,000, preferably about 2,000 to about 5,000, most preferably about 4,000 to about 5,000, and having random ethylene oxide units and higher alkylene oxide units in a mol ratio of ethylene oxide (EO) to higher alkylene oxide of 1:1 to 4:1. The higher alkylene oxide can be selected from the group consisting of propylene oxide (PO), butylene oxide, pentylene oxide, hexylene oxide and mixtures thereof. The hydrophilic polyol is preferably a polyoxyethylene-propylene polyol comprising, for example, 50 to 70% EO and 30 to 50% PO. A particularly preferred polyether triol is one comprising approximately 68% EO and approximately 32% PO. Alternate ratios of EO:PO can be used in preparing the hydrophilic polyol provided that the hydrophilicity of the resulting polyol is not significantly adversely affected. These ratios can be determined by routine testing.

Commercially available polyol precursors useful in making the above described isocyanate-terminated prepolymers are hydrophilic polyether polyols, for example, a POLY-G triol, such as POLY-G-83-34 (70 percent ethylene oxide and 30 percent propylene oxide), available from Arch Chemicals, Norwalk, Conn. The degree of overall hydrophilicity of the prepolymeric mixtures can be modified by varying the ratio of ethylene oxide to propylene oxide in the hydrophilic polyol, or by using small amounts of poly(oxyethylene-oxypropylene) polyols sold under the trademark PLURONIC, such as PLURONIC-L35 and PLURONIC-F38, available from BASF Corporation, Florham Park, N.J., or hydrophilic polyols with heteric oxyethylene-oxypropylene chain.

Polyisocyanates that can be used to prepare the prepolymers having isocyanate groups include aliphatic, alicyclic, and aromatic polyisocyanates, and mixtures and combinations thereof. Useful polyisocyanates (or isocyanate monomers) have an average isocyanate functionality of at least about 2 (preferably, about 2 to about 5; more preferably, about 2).

Preferably, the polyisocyanates are aromatic polyisocyanates (for example, due to greater reactivity rate). One of the most useful polyisocyanate compounds that can be used is tolylene diisocyanate (TDI), particularly as a blend of 80 weight percent of tolylene-2,4-diisocyanate and 20 weight percent of tolylene-2,6-diisocyanate. A 65:35 blend of the 2,4- and 2,6-isomers can also be used. These polyisocyanates are commercially available under the trademark HYLENE from DuPont Chemical Solutions Enterprise, Wilmington, Del., and as MONDUR TD-80 from Bayer Material Science LLC, Pittsburgh, Pa. The tolylene diisocyanates can also be used as a mixture with methylene diphenyl diisocyanate.

Other polyisocyanate compounds that can be used (alone or in combination) include other isomers of tolylene diisocyanate; hexamethylene diisocyanate (HDI) including, for example, the 1,6 isomer; xylene diisocyanate (XDI); methylene diphenyl diisocyanate (MDI) including, for example, diphenylmethane-4,4′-diisocyanate; m- or p-phenylene diisocyanate; isophorone diisocyanate (IPDI); 1,5-naphthalene diisocyanate; tetramethylene diisocyanate; 1,4-cyclohexane diisocyanate; hexahydrotolylene diisocyanate; 1-methoxy-2,4-phenylene diisocyanate; 2,4-diphenylmethane diisocyanate; 4,4′-biphenylene diisocyanate; 3,3′-dimethoxy-4,4′-biphenyl diisocyanate; 3,3′-dimethyl-4, 4′-biphenyl diisocyanate; 3,3′-dimethyl-4,4′-diphenylmethane diisocyanate; and the like; and mixtures thereof. Polymeric polyisocyanates can also be used (for example, polymethylene polyphenyl polyisocyanates, such as those sold under the trademarks MONDUR MRS and PAPI by Bayer Material Science LLC, Pittsburgh, Pa.). A list of useful commercially available polyisocyanates can be found in Kirk-Othmer Encyclopedia of Chemical Technology, 2nd Ed., Vol. 12, pages 46-47, Interscience Publishers (1967).

Preferred isocyanates include tolylene diisocyanate (TDI), hexamethylene diisocyanate (HDI), methylene diphenyl isocyanate (MDI), xylene diisocyanate (XDI), and the like, and mixtures thereof.

As stated above, isocyanate-functional prepolymers can be formed by reacting a polyol and an excess of monomeric polyisocyanate. Useful prepolymers can have, for example, an isocyanate (NCO) content of about 11.5 percent by weight or less and an average NCO functionality of about 4 or less. The prepolymer is preferably a urethane-containing polymer bearing isocyanate groups.

The prepolymer bearing isocyanate groups can be prepared, for example, by reacting a polyisocyanate with a copolymer of polyoxyethylene-propylene polyol using an NCO/OH equivalent ratio of about 5:1 to about 1.05:1, preferably a ratio of about 2.0:1 to 2.5:1. The preparation of isocyanate-terminated prepolymers is described, for example, in U.S. Pat. No. 4,315,703 (Gasper) and U.S. Pat. No. 4,476,276 (Gasper) and references therein, the descriptions of which are incorporated herein by reference. Benzoyl chloride can be added during prepolymer preparation to avoid side reactions of polyisocyanate. Preferably, no solvent is used to dilute the prepolymer. However, a solvent can be used if necessary or desired.

Solvents that can be used to dissolve the prepolymer include water-miscible, polar organic solvents that are preferably volatile at the ambient conditions of the environment where the composition is to be used. The solvent chosen preferably is such that the resulting solution of prepolymers and solvent will not freeze at the ambient conditions present in the environment where the mixed composition of the invention is to be applied. For example, where the ambient temperature is about 50°F., a solution of about 60-90 (or higher) weight percent of prepolymer solids in dry acetone is an effective composition. Other useful water-miscible solvents include methyl acetate, tetrahydrofuran, glycol monoethyl ether acetate (sold under the trade designation “Cellosolve” acetate), diethyl acetal, and hydrophilic plasticizers, such as ATPOL 1120 polyether, available from Uniquema, Belgium.

Following prepolymer preparation, purification of the prepolymer is preferably carried out to remove unreacted monomeric polyisocyanate. This is preferably accomplished by quenching the unreacted monomeric polyisocyanate with a compound that is reactive to isocyanate groups, so that the prepolymer preferably contains less than about 0.7 weight percent (more preferably, less than about 0.5 weight percent) of unreacted monomeric polyisocyanate.

Unless the amount of unreacted monomeric polyisocyanate present in the mixture containing the prepolymer is lowered through a purification step or effectively reduced by, for example, quenching the isocyanate groups of the monomeric polyisocyanate, the presence of the monomeric polyisocyanate can result in toxicity (for example, during spraying of the liner composition). Also, it has been discovered that by removing or quenching the unreacted monomeric polyisocyanates, preferred liners of superior strength can be produced. Other advantages can include reduced toxicity and lowered heat generation.

The prepolymer can be purified from unreacted monomeric polyisocyanate by processes and/or methods using, for example, falling film evaporators, wiped film evaporators, distillation techniques, various solvents, molecular sieves, or organic reactive reagents such as benzyl alcohol. U.S. Pat. No. 4,061,662 (Marans et al.) describes the removal of unreacted tolylene diisocyanate (TDI) from an isocyanate prepolymer by contacting the prepolymer with molecular sieves. U.S. Pat. No. 3,248,372 (Bunge), U.S. Pat. No. 3,384,624 (Heiss), and U.S. Pat. No. 3,883,577 (Rabizzoni et al.) describe processes related to removing free isocyanate monomers from prepolymers by solvent extraction techniques. It is also possible to distill an isocyanate prepolymer to remove the unreacted diisocyanate according to U.S. Pat. No. 4,385,171 (Schnabel et al.). It is said to be necessary to use a compound that is only partially miscible with the prepolymer and that has a higher boiling point than that of the diisocyanate to be removed. U.S. Pat. No. 3,183,112 (Gemassmer), U.S. Pat. No. 4,683,279 (Milligan et al.), U.S. Pat. No. 5,051,152 (Siuta et al.), and U.S. Pat. No. 5,202,001 (Starner et al.) describe the use of falling film and/or wiped film evaporation. According to U.S. Pat. No. 5,502,001 (Okamoto), the residual TDI content can be reduced to less than 0.1 weight percent by passing the prepolymer at ˜100° C. through a wiped film evaporator, while adding an inert gas, especially nitrogen, to the distillation process to sweep out the TDI. The purification method descriptions of all of these references are incorporated herein by reference.

In a preferred purification method, unreacted preferably monomeric polyisocyanates can be quenched with an amine (preferably, a secondary amine; more preferably, a monofunctional secondary amine) or an alcohol (for example, an arylalkyl alcohol), preferably in the presence of a tertiary amine catalyst (such as, for example, triethylamine) or an alkoxysilane bearing a functional group that is reactive to isocyanate groups (for example, an amine). The unreacted polyisocyanates are more preferably reacted with an arylalkyl alcohol, such as benzyl alcohol, used with a tertiary amine. The unreacted polyisocyanates are most preferably reacted with an arylalkyl alcohol, such as benzyl alcohol, used in conjunction with an alkoxysilane bearing one secondary amino group. The unreacted polyisocyanates can be quenched without substantially affecting the terminal isocyanate groups of the prepolymer.

Examples of amines that are suitable for use in such a purification method include N-alkyl aniline (for example, N-methyl or N-ethyl aniline and its derivatives), diisopropylamine, dicyclohexylamine, dibenzylamine, diethylhexylamine, and the like, and mixtures thereof.

Examples of suitable alcohols include arylalkyl alcohols (for example, benzyl alcohol and alkyl-substituted derivatives thereof); free-radically polymerizable, hydroxyl-functional monomers; and the like; and mixtures thereof.

Examples of suitable silanes include DYNASYLAN 1189 (N-(n-butyl)-aminopropyltrimethoxysilane and DYNASYLAN DAMO (N-2-aminoethyl-3-aminopropyltrimethoxysilane), both available from Degussa Corporation, Parsippany, N.J.; SILQUEST A-1170 (bis (trimethoxysilylpropyl)amine and SILQUEST Y-9669 (N-phenyl)-gamma-aminopropyltrimethoxysilane, both available from GE-Advanced Materials, Wilton, Conn.; and the like; and mixtures thereof.

When alcohols are used to quench the unreacted polyisocyanates, the application of heat can be used to reduce the reaction time. Reactions with amines can generally be conducted, however, at ambient temperature for a relatively shorter period of time.

The amount of unreacted monomeric polyisocyanate present in the reaction mixture comprising the prepolymer following the reaction with the amine, alcohol, or silane is most preferably 0, but preferably can range up to about 0.7 weight percent, more preferably up to about 0.5 weight percent.

A preferred method of purifying the prepolymer is by the method of U.S. Pat. No. 6,664,414 (Tong et al.), the disclosure of which is incorporated herein by reference.

The hydrophilic prepolymer can be combined with the wet pulp-containing, water-borne polymer dispersion, preferably essentially immediately before application to a surface. As an example of the combination or mixing process, the components can be pumped using positive displacement pumps and then mixed in a static mixer before being sprayed onto a surface. The mixture can be sprayed with or without air pressure (preferably without). The efficiency of mixing depends on the length of the static mixer. Useful application equipment includes, for example, a pump available from Graco, Inc., Minneapolis, Minn., as GUSMER Model H20/35, having a 2-part proportioning high pressure spray system that feeds through a heated temperature controlled (for example, 60° C.) zone to an air purging impingement mixing spray head gun of, for example, type GAP (Gusmer Air Purge) also available from Graco, Inc.

The product of the reaction of hydrophilic prepolymer and the polymer dispersion is a gelatinous mass, as the hydrophilic moieties of the hydrophilic prepolymer absorb water that is the vehicle of the polymer. This gelatinous mass is sometimes referred to as a gel or hydrogel, and it can be used, for example, as a liner in a mine. Reaction times to convert the prepolymer to the gel can be on the order of less than a minute to several hours.

By including wet pulp in the liner composition, the initial yield strength of the resulting liner can be enhanced (relative to a liner produced from the corresponding composition without wet pulp). For example, 4-hour Yield Strengths of at least about 0.3MPa can often be achieved, even under relatively high humidity and relatively low air flow conditions.

By utilizing, in addition to wet pulp, a sufficiently high solids content dispersion comprising polymer having a sufficiently high modulus and glass transition or crystalline melting temperature, the formed gel generally develops a minimum tensile strength of at least about 2.5 MPa within about 24 hours (and, preferably, a minimum tensile strength of at least about 1 MPa within about four hours, more preferably within about 2-4 hours). The solids content of the dispersion and the modulus and glass transition or crystalline melting temperature of the polymer can be varied over a wide range, and the skilled artisan will recognize that a high value for one or two of these parameters can be selected so as to compensate for a low value (for example, a value outside of the preferred ranges described above) of another.

The tensile strength of the liner after it is completely formed (fully cured) is preferably at least about 6-15 MPa, more preferably at least about 8-15 MPa, at room temperature. (When “cured,” the product of reaction of the composition has generally lost most of its water content (for example, more than about 90 percent) and crosslinking is essentially completed.) When the liner-producing composition of the present invention is applied at colder temperatures or under high humidity conditions, longer periods of time can be required for the liner to become fully cured. Tensile strength build-up can be accelerated, if desired, by the application of heat during and after application of the components (for example, to accelerate the rate of water evaporation and crosslinking).

When component (a) contains at least about 30% by weight of solid polymer, the weight ratio of component (a) to isocyanate prepolymer is preferably in the range of about 3:1 to about 10:1, more preferably from about 4:1 to about 7:1, and most preferably from about 5:1 to about 6:1, but, when component (a) has a higher solids content than about 50% by weight, the ratio can sometimes be 1:1 for some applications. However, to increase the hydrophobicity of the resulting liner it is desirable and preferred to use as little isocyanate prepolymer as possible.

The liner of the present invention is preferably gas-tight and flexible. The liner, when fully cured, preferably has an elongation at break of from about 100 to about 1000%, more preferably from about 200 to about 800%, even more preferably from about 200 to about 600%, most preferably from about 300 to about 500%. The resulting liner is, therefore, preferably, a water-insoluble, cross-linked, water-containing gelatinous mass having a high degree of flexibility.

The liners produced according to the invention can be used as load-bearable coatings to support, for example, rock surfaces in a mine. For such applications, the liners are preferably thick, around 0.5 mm to 6 mm, when cured completely and after removal of aqueous solvent.

Other additive ingredients can be included in the composition and liner of the present invention. For example, viscosity modifiers can be included to increase or decrease the viscosity, depending on the desired application technique. Fungicides can be added to prolong the life of the liner and to prevent attack by various fungi. Other active ingredients can be added for various purposes, such as substances to prevent encroachment of plant roots, and the like. Other additives that can be included in the composition and liner of this invention, include, without limitation, Theological additives, fillers, fire retardants, defoamers, antioxidants, stabilizers, and coloring matters. Care should generally be exercised in choosing fillers and other additives to avoid any materials that will have a deleterious effect on the viscosity, the reaction time, the stability of the liner being prepared, and the mechanical strength of the resulting liner.

The additional materials that can be included in the composition and liner of the present invention can provide a more shrink-resistant, substantially incompressible, and fire retardant liner. Any of a number of filler compositions have been found to be particularly effective. Useful fillers include water-insoluble particulate filler material having a particle size of about less than 500 microns, preferably about 1 to 50 microns, and a specific gravity in the range of about 0.1 to 4.0, preferably about 1.0 to 3.0. The filler content of the cured liner of the present invention can be as much as about 10 parts filler per 100 parts by weight cured liner, preferably about 5 parts to about 10 parts per 100.

Examples of useful additives for this invention include expandable graphite (for example, at levels up to about 5 weight percent of the cured liner) such as GRAFGUARD 220-80B or GRAFGUARD 160-150B (Graftech Advanced Energy Technology, Inc., Lakewood, Ohio, USA); silica such as quartz, glass beads, glass bubbles, and glass fibers; silicates such as talc, clays, (montmorillonite) feldspar, mica, calcium silicate, calcium metasilicate, sodium aluminosilicate, and sodium silicate; metal sulfates such as calcium sulfate, barium sulfate, sodium sulfate, aluminum sodium sulfate, and aluminum sulfate; gypsum; vermiculite; wood flour; aluminum trihydrate; carbon black; aluminum oxide; titanium dioxide; cryolite; chiolite; and metal sulfites such as calcium sulfite. Preferred additives include expandable graphite, feldspar, and quartz, and mixtures thereof. The additive is most preferably expandable graphite. The amount of additive added to the liner composition of the invention preferably can be chosen so that there is no significant effect on elongation or tensile strength of the resulting liner. Such amounts can be determined by routine investigation.

When additive is utilized, the resulting liner can also be fire retardant. For some applications, the liner preferably can meet the fire retardant specifications of CAN/ULC-S102-M88 or ASTM E-84. These tests determine bum rate and the amount of smoke generation.

Objects and advantages of this invention are further illustrated by the following examples, but the particular materials and amounts thereof recited in these examples, as well as other conditions and details, should not be construed to unduly limit this invention.

### EXAMPLES

Glossary of Materials

TWARON 5011—a poly(paraphenylene terephthalamide) polymer powder, 55 micrometer average particle size, 97% solids, available from Teijin Twaron USA Inc., Conyers, Ga., USA
TWARON 1088—a poly(paraphenylene terephthalamide) 250 micrometer chopped fiber, 100% solids, available from Teijin Twaron USA Inc., Conyers, Ga., USA
TWARON 1092—a poly(paraphenylene terephthalamide) wet pulp, 31.5% solids, 750-1200 micrometers weighted average length, low degree of fibrillation (CSF 600), available from Teijin Twaron USA Inc., Conyers, Ga., USA
TWARON 1094—a poly(paraphenylene terephthalamide) wet pulp, 34% solids, 650-1050 micrometers weighted average length, high degree of fibrillation (CSF 170), available from Teijin Twaron USA Inc., Conyers, Ga., USA
KEVLAR/Merge IF 361—a poly(paraphenylene terephthalamide) wet pulp, 34% solids, 650-1050 micrometers weighted average length, high degree of fibrillation (CSF 155), available from DuPont Canada Inc., Advanced Fibers Systems, Mississauga, Ontario
SHORT STUFF E400M—a polyethylene synthetic wet pulp, 43.7% solids, 700-1150 micrometers length, low degree of fibrillation (CSF 580), available from MiniFIBERS, Inc, Johnson City, Tenn., USA
SHORT STUFF Y400M—a polypropylene synthetic wet pulp, 43.3% solids, 800-1400 micrometers length, low degree of fibrillation (CSF 720), available from MiniFIBERS, Inc, Johnson City, Tenn., USA
NEOPAC R-9050—a water-borne urethane/acrylic copolymer, 50% solids, available from DSM NeoResins, Wilmington, Mass., USA
CARBOPOL EDT 2691—hydrophobically-modified, crosslinked polyacrylate powder, 100% solids, available from Noveon, Inc., Cleveland, Ohio, USA
FOAMASTER 111—a silicone-free, broad spectrum petroleum derivative non-phase separating defoamer, non-ionic yellow liquid, available from Cognis Canada Corporation, Mississauga, Ontario, Canada
GRAFGUARD 220-80B—a graphite/acid washed graphite flake, available from Advanced Energy Technology, Inc., Lakewood, Ohio, USA
Triethylamine—N,N-diethylethanamine, CAS#: 121-44-8, available from Air Products and Chemicals, Inc., Allentown, Pa., USA
   Preparation of Part A (Comprising Isocyanate Prepolymer)

An amount of benzoyl chloride (0.032 percent, based on the total amount of polyol and tolylene diisocyanate (TDI)) was blended at room temperature under an inert atmosphere with 1 equivalent of polyether triol (a copolymer of ethylene oxide and propylene oxide sold under the trade designation POLY-G-83-34, mol. wt. 5400, available from Arch Chemicals, Norwalk, Connecticut). Thereafter, 2.4 equivalents of an 80:20 mixture of 2,4-tolylene diisocyanate and 2,6-tolylene diisocyanate (MONDUR TD-80, available from Bayer Material Science LLC, Pittsburgh, Pa., USA) was added to the resulting mixture with agitation, producing a moderate exotherm. The mixture was maintained at 80-85° C. for 3 hours. A dispersion of FD&C Blue No. 1 dye (0.024 percent, based on the total composition, available from Noveon Hilton Davis Inc, Cincinnati, Ohio) in POLY-G-83-34 polyether triol (0.01 equivalent) was added to the mixture, and the resulting mixture was maintained at 80-85° C. until the reaction was completed. After cooling to room temperature, the mixture (hereinafter, termed “Prepolymer 1”) contained prepolymers having on average 3.0 to 3.2 weight percent isocyanate groups, and 1.2-2.4 weight percent monomeric TDI, as determined by nuclear magnetic resonance (NMR) techniques.

To a reactor (equipped with a mechanical stirrer and a thermometer) containing Prepolymer 1 was added under an argon atmosphere 17 mol percent (with respect to the total NCO groups in Prepolymer 1) of SILQUEST A-1170 bis(trimethoxysilyl-propyl)amine (available from GE-Advanced Materials, Wilton, Conn.) dropwise at 25° C. with stirring. The resulting reaction was exothermic, causing a 0-10° C. increase in temperature. After complete addition, the resulting mixture was allowed to react for 2 hours at 40° C. and then for 2 hours at 50° C. The mixture was collected after that period.

Preparation of Part B (Comprising a Water-Borne Precursor of a Polyurethane)

A premix was prepared by adding multiples of 96 g of de-ionized water into a suitably sized, non-reactive mixing vessel equipped with a variable speed agitator and 2 sets of impeller blades. The variable speed mixer was capable of agitation rates of 800-1200 revolutions per minute (rpm). CARBOPOL EDT 2691 (4 g for each 96 g of de-ionized water) was added slowly and carefully to the de-ionized water with rapid stirring. The agitation was continued for about 1 hour or until an essentially lump-free gelatinous dispersion was attained. The pH of this dispersion was in the range of 2-3, with solids of 4 percent by weight.

100 parts by weight of NEOPAC R-9050 (which contained 50 parts by weight of polymer solids or “resin”) was added to a suitably sized, non-reactive mixing vessel. The mixing vessel was a low shear type mixer that was capable of variable speed. The mixing blades were mixed flow impeller type with either a regular or high lift pitch. The agitation rate was set to 550 rpm, and from 0-4 parts per hundred resin (phr; that is, parts by weight 20 per one hundred parts by weight of resin) of a selected additive (for example, a wet pulp) was added slowly into the vortex of the NEOPAC R-9050. The resulting mixture was agitated for about 1-4 hours, depending upon the degree of fibrillation of the additive.

Then, 0.28 phr of a 4 weight percent CARBOPOL EDT 2691 solution was added to the mixture. The mixture was agitated for 30 minutes, during which time the viscosity of the mixture increased appreciably. The agitation rate was increased to 650 rpm during this time.

0.23 phr of triethylamine was added to the thickened mixture, and the resulting mixture was agitated for an additional 15 minutes. 0.10 phr of FOAMASTER 111 was added to the thickened, neutralized mixture, and the resulting mixture was mixed an additional 15 minutes. 4 phr of GRAFGUARD 220-80B was added to the mixture, which was then agitated for an additional 30 minutes. The resulting mixture had a pH in the range of 7.7-8.3, solids of 49-51 percent, and a viscosity of 7-12 Pa s (7,000-12000 cps). The solids content of the mixture was measured at 92° C. for 20 hours, and the viscosity of the mixture was measured by using a TA Instruments AR-2000 Rheometer using 25 mm parallel plates.

Casting of Films

The casting of films for performance evaluation was carried out using either a 4:1 or a 6:1 volume ratio of Part B to Part A in dual cartridges. For 4:1 cast films, 4:1 ratio by volume cartridges (such as those available from ConProTec, Inc., Salem, N.H., USA under the name MIXPAC System 200 or MIXPAC System 400) were used. The contents of the 4:1 cartridges were dispensed with a pneumatic dispenser. Preferred static mixers that were utilized included from 18 to 24 elements, depending upon the particular composition. 6:1 ratio cast films were prepared using 6:1 ratio by volume cartridges (such as those available from Plas-Pak Industries, Inc, Norwich, Conn., USA). The contents of the 6:1 by volume cartridges were dispensed with a RATIO-PAK HSS Spray System. A 0.95 cm (⅜″) internal diameter (ID)×24 elements static mixer was used. After the appropriate cartridge was filled and the end caps were positioned, each Part A cartridge was heated to 45° C. to reduce the viscosity of Part A prior to use.

The dual cartridges were dispensed into a slotted mold (made of polytetrafluoroethylene-treated aluminum) of 3 mm thickness, 5 cm width, and 22 cm height. The films generated upon removal from the mold were immediately placed into an environmental chamber with conditions of either (a) 23° C., 70 percent relative humidity (RH), and less than 15.2 m/minute (50 fpm) air flow; or (b) 24° C., 70 percent RH, and approximately 60.9 m/minute (200 fpm) air flow. The films were left for pre-determined drying periods of hours to months and then tested for physical properties including yield point, tensile strength, elongation, and toughness using the above-cited Test Method ASTM D-412-98a (using Die C) at a crosshead speed of 200 mm/minute.

Spraying of Films

Sprayed films were generated using a GUSMER H20/35 Plural Component Proportioner with 5.8:1 volume ratio, available from GRACO Inc, Minneapolis, Minn., USA. A GUSMER GAP plural-component air purge gun with 04 mix chamber, 03 tip, and a 2.54 cm (one inch) mixer body with a 5-element static mixer was used to spray a mixture of Part A and Part B onto 0.05 mm or 0.10 mm thickness, untreated polyethylene sheeting. The resulting films were conditioned, removed from the sheeting, and evaluated under essentially the same conditions as those described above for cast films.

### Examples 1-8 and Comparative Example C-1

Samples were prepared essentially by following the above-described procedures for the preparation of Parts A and B and of cast films, using the various additives (and amounts thereof) shown in Tables 1 and 2 below. Comparative Example C-1 contained no additive. Examples 1-4 contained a low-fibrillated aramid wet pulp at various loading levels. Examples 5 and 6 contained a high-fibrillated aramid wet pulp. Examples 7 and 8 contained non-aramid, low-fibrillated wet pulps with fiber lengths similar to those of the aramid wet pulps. The physical properties of 6:1 by volume ratio cast films were measured essentially as described above after conditioning at 23° C., 70 percent RH, and less than 15.2 m/minute (50 fpm) air flow for time periods of 4 hours, 24 hours, and 1 week after casting, respectively, and the results are shown in Tables 1 and 2 below. The term “processability” (in the tables below) refers to the ease of incorporation of the additive during the preparation of the Part B component.

TABLE 1

| | | | | Yield | Tensile | | |
|---|---|---|---|---|---|---|---|
| | | Additive | | Strength | Strength | Toughness | Elongation |
| Example | | Loading | Process- | @ 4 hours | @ 4 hours | @ 4 hours | @ 4 hours |
| No. | Additive | (phr) | ability | (MPa) | (MPa) | (MPa) | (%) |
| C-1 | None | | Easy | 0.19 | 2.07 | 6.53 | 595 |
| 1 | TWARON | 0.50 | Moderate- | 0.44 | 2.32 | 7.79 | 630 |
| | 1092 | | Easy | | | | |
| 2 | TWARON | 0.75 | Moderate- | 0.43 | 1.94 | 7.34 | 658 |
| | 1092 | | Easy | | | | |
| 3 | TWARON | 0.82 | Moderate- | 0.61 | 2.68 | 10.18 | 703 |
| | 1092 | | Easy | | | | |
| 4 | TWARON | 0.94 | Moderate- | 0.52 | 1.80 | 5.90 | 531 |
| | 1092 | | Easy | | | | |
| 5 | KEVLAR | 0.50 | Very | 0.59 | 2.03 | 6.65 | 549 |
| | 1F361 | | Difficult | | | | |
| 6 | KEVLAR | 0.75 | Very | 0.72 | 1.99 | 6.99 | 550 |
| | 1F361 | | Difficult | | | | |
| 7 | SHORT | 1 | Easy | 0.23 | 1.59 | 5.12 | 578 |
| | STUFF | | | | | | |
| | E400M | | | | | | |
| 8 | SHORT | 1 | Easy | 0.26 | 1.67 | 5.86 | 621 |
| | STUFF | | | | | | |
| | Y600M | | | | | | |

TABLE 2

| | | | | | | Yield | Tensile | |
|---|---|---|---|---|---|---|---|---|
| | | | Yield | Tensile | | Strength | Strength | |
| | | Additive | Strength | Strength | Elongation | @ 1 | @ 1 | Elongation |
| Example | | Loading | @ 24 hours | @ 24 hours | @ 24 | week* | week* | @ 1 week* |
| No. | Additive | (phr) | (MPa) | (MPa) | hours (%) | (MPa) | (MPa) | (%) |
| C-1 | None | | 0.85 | 3.67 | 556 | 3.00 | 8.87 | 582 |
| 1 | TWARON | 0.50 | 0.96 | 4.42 | 670 | 2.52 | 9.54 | 696 |
| | 1092 | | | | | | | |
| 2 | TWARON | 0.75 | 0.85 | 2.63 | 575 | 2.85 | 7.77 | 623 |
| | 1092 | | | | | | | |
| 3 | TWARON | 0.82 | 1.34 | 5.67 | 707 | 2.73 | 9.69 | 708 |
| | 1092 | | | | | | | |
| 4 | TWARON | 0.94 | 1.56 | 6.52 | 712 | 3.18 | 11.52 | 722 |
| | 1092 | | | | | | | |
| 5 | KEVLAR | 0.50 | 1.24 | 4.72 | 675 | 3.16 | 9.61 | 661 |
| | IF361 | | | | | | | |
| 6 | KEVLAR | 0.75 | 1.32 | 2.79 | 457 | 3.39 | 7.70 | 565 |
| | IF361 | | | | | | | |
| 7 | SHORT | 1 | 0.65 | 3.43 | 685 | 2.63 | 7.88 | 609 |
| | STUFF | | | | | | | |
| | E400M | | | | | | | |
| 8 | SHORT | 1 | 0.56 | 2.41 | 500 | 2.41 | 7.32 | 653 |
| | STUFF | | | | | | | |
| | Y600M | | | | | | | |

*Under the above-stated temperature and humidity conditions, the samples were not fully cured after 1 week.

### Examples 9-12 and Comparative Examples C-2-C-5

Samples were prepared essentially by following the above-described procedures for the preparation of Parts A and B and of cast films, using the various additives (and amounts thereof) shown in Table 3 below. Comparative Example C-2 contained no additive, and Comparative Examples C-3-C-5 contained either “dry” aramid particulate or cut fibers, rather than wet pulp. Examples 9 and 10 contained a low-fibrillated aramid wet pulp at various loading levels. Examples 11 and 12 contained a high-fibrillated aramid wet pulp. The physical properties of 4:1 by volume ratio cast films were measured essentially as described above after conditioning at 23° C., 70 percent RH, and less than 15.2 m/minute (50 fpm) air flow for a time period of 4 hours after casting, and the results are shown in Table 3 below. The term “processability” (in the table below) refers to the ease of incorporation of the additive during the preparation of the Part B component.

TABLE 3

| | | | | Yield | Tensile | | |
|---|---|---|---|---|---|---|---|
| | | Additive | | Strength | Strength | Toughness | Elongation |
| Example | | Loading | Process- | @ 4 hours | @ 4 hours | @ 4 hours | @ 4 hours |
| No. | Additive | (phr) | ability | (MPa) | (MPa) | (MPa) | (%) |
| C-2 | None | | Easy | 0.24 | 2.99 | 9.73 | 672 |
| C-3 | TWARON | 0.75 | Easy | 0.15 | 2.18 | 5.59 | 525 |
| | 5011 | | | | | | |
| C-4 | TWARON | 1 | Easy | 0.17 | 2.33 | 6.21 | 527 |
| | 5011 | | | | | | |
| C-5 | TWARON | 1 | Easy | 0.25 | 2.87 | 8.81 | 528 |
| | 1088 | | | | | | |
| 9 | TWARON | 0.63 | Moderate- | 0.32 | 2.31 | 7.96 | 608 |
| | 1092 | | Easy | | | | |
| 10 | TWARON | 0.94 | Moderate- | 0.44 | 2.19 | 7.54 | 562 |
| | 1092 | | Easy | | | | |
| 11 | TWARON | 0.34 | Difficult | 0.29 | 2.08 | 6.81 | 578 |
| | 1094 | | | | | | |
| 12 | TWARON | 0.68 | Difficult | 0.47 | 2.11 | 7.52 | 541 |
| | 1094 | | | | | | |

### Examples 13-16 and Comparative Examples C-6-C-8

Samples were prepared essentially by following the above-described procedures for the preperation of Parts A and B and of sprayed films, using the various additives (and amounts therof) shown in Tables 4 and 5 below. Comparative Example C-6 contained no additive, and Comparative Examples C-7 and C-8 contained “dry” aramid cut fibers, rather than wet pulp. Examples 13-16 contained a low-fibrillated aramid wet pulp at various loading levels. The physical properties of 5.8:1 by volume ratio sprayed films were measured essentially as described above after conditioning at 23° C., 70 percent RH, and less than 15.2 m/minute (50 fpm) air flow for various time periods after spraying (except “initial” means measured essentially immediately after spraying), and the results are shown in Tables 4 and 5 below. The term “sprayability” (in the tables below) refers to the ease of spraying the various sample compositions.

TABLE 4

| | | | | | Yield | Yield | Yield |
|---|---|---|---|---|---|---|---|
| | | | | Yield | Strength | Strength | Strength |
| | | Additive | | Strength, | @ 2 | @ 4 | @ 24 |
| Example | | Loading | Spray- | Initial | hours | hours | hours |
| No. | Additive | (phr) | ability | (MPa) | (MPa) | (MPa) | (MPa) |
| C-6 | None | | Good | 0.11 | 0.16 | 0.12 | 0.28 |
| C-7 | TWARON | 1 | Fair-Poor | n/d | n/d | 0.21 | 0.72 |
| | 1088 | | | | | | |
| C-8 | TWARON | 4 | Restricted | n/d | n/d | 0.32 | 0.81 |
| | 1088 | | | | | | |
| 13 | TWARON | 0.5 | Fair | 0.30 | 0.27 | 0.35 | 0.92 |
| | 1092 | | | | | | |
| 14 | TWARON | 0.7 | Fair | n/d | 0.46 | 0.37 | 0.54 |
| | 1092 | | | | | | |
| 15 | TWARON | 0.82 | Fair-Poor | 0.40 | 0.45 | 0.46 | 0.86 |
| | 1092 | | | | | | |
| 16 | TWARON | 0.94 | Poor | n/d | 0.39 | 0.47 | 0.66 |
| | 1092 | | | | | | |

TABLE 5

| | | | Tensile | | |
|---|---|---|---|---|---|
| | | Additive | Strength | Toughness | Elongation |
| Example | | Loading | @ 4 hours | @ 4 hours | @ 4 |
| No. | Additive | (phr) | (MPa) | (MPa) | hours (%) |
| C-6 | None | | 1.32 | 4.49 | 501 |
| C-7 | TWARON | 1 | 1.94 | 5.24 | 520 |
| | 1088 | | | | |
| C-8 | TWARON | 4 | 1.88 | 6.14 | 554 |
| | 1088 | | | | |
| 13 | TWARON | 0.5 | 1.14 | 2.65 | 372 |
| | 1092 | | | | |
| 14 | TWARON | 0.7 | 1.48 | 3.95 | 465 |
| | 1092 | | | | |
| 15 | TWARON | 0.82 | 1.48 | 4.65 | 534 |
| | 1092 | | | | |
| 16 | TWARON | 0.94 | 1.47 | 3.91 | 441 |
| | 1092 | | | | |

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to b unduly limited by the illustrative embodiments and examples set forth herein and that such examples and embodiments are presented by way of example only, with the scope of the invention intended to be limited only by the claims set forth herein as follows:

We claim:

1. A composition comprising
(a) at least one water-borne, non-cellulosic precursor of a polyurethane;
and
(b) at least one wet pulp.

2. The composition of claim 1, wherein said precursor is a precursor of a polyurethane hydrogel.

3. The composition of claim 1, wherein said precursor is a water-borne, non-cellulosic polymer dispersion, said polymer bearing groups that are reactive with groups selected from isocyanate groups, acryloyl groups, methacryloyl groups, epoxy groups, acid chloride groups, and mixtures thereof.

4. The composition of claim 1, wherein said precursor is a water-borne, non-cellulosic polymer dispersion, said polymer bearing groups that are reactive with isocyanate groups.

5. The composition of claim 1, wherein the water content of component (a) is at least about 30 percent by weight, based upon the total weight of water and said precursor.

6. The composition of Claim 1, wherein said composition further comprises at least one hydrophilic prepolymer bearing isocyanate groups.

7. The composition of claim 1, wherein said wet pulp comprises fibrous material selected from natural animal fibers, natural vegetable fibers, synthetic fibers, and mixtures thereof.

8. The composition of claim 1, wherein said wet pulp comprises fibrous material selected from cellulose fibers, polyolefin fibers, polyamide fibers, and mixtures thereof.

9. The composition of claim 1, wherein said wet pulp comprises fibrous material selected from polyamide fibers and mixtures thereof.

10. The composition of claim 1, wherein said wet pulp comprises fibrous material selected from aramid fibers and mixtures thereof.

11. The composition of claim 1, wherein said wet pulp comprises fibrous material selected from para-aramid fibers and mixtures thereof.

12. The composition of claim 1, wherein said wet pulp comprises fibrous material that is fibrillated.

13. The composition of claim 1, wherein said wet pulp comprises fibrous material that is low-fibrillated.

14. The composition of claim 1, wherein the water content of component (b) is at least about 40 percent by weight, based upon the total weight of said wet pulp.

15. A composition comprising
(a) at least one water-borne, non-cellulosic polymer dispersion, said polymer bearing groups that are reactive with isocyanate groups;
(b) at least one hydrophilic prepolymer bearing isocyanate groups; and
(c) at least one wet pulp comprising fibrous material selected from para-aramid fibers and mixtures thereof.

16. A liner comprising the polymeric product of reaction of the composition of claim 1.

17. A liner comprising the polymeric product of reaction of the composition of claim 15.

18. The liner of claim 16, wherein said liner exhibits a 4-hour Yield Strength of at least 0.3 MPa.

19. The liner of claim 17, wherein said liner exhibits a 4-hour Yield Strength of at least 0.3 MPa.

20. A mine opening at least partially lined with the liner of claim 16.

21. A mine opening at least partially lined with the liner of claim 17.

22. A building structure having at least one non-trafficable surface that is at least partially lined with the liner of claim 16.

23. A building structure having at least one non-trafficable surface that is at least partially lined with the liner of claim 17.

24. A process comprising
(a) applying to a surface the composition of claim 1; and
(b) effecting reaction of said composition to form a polymeric liner.

25. The process of claim 24, wherein said surface is in a mine opening.

26. A kit comprising the composition of claim 1, which, when subjected to reaction conditions, reacts to form a polymeric material suitable for use as a liner.

27. A kit comprising the composition of claim 15, which, when subjected to reaction conditions, reacts to form a polymeric material suitable for use as a liner.
